(19) United States
(12) Patent Application Publication
(10) Pub. No.: US 2024/0005419 A1
(43) Pub. Date: Jan. 4, 2024

(54) PROACTIVE SEISMIC REHABILITATION OF WATER PIPE NETWORKS FOR EQUITABLE RECOVERY

(71) Applicant: Board of Regents, The University of Texas System, Austin, TX (US)

(72) Inventors: Mohsen Shahandashti, Arlington, TX (US); Binaya Pudasaini, Hillsboro, OR (US)

(21) Appl. No.: 18/308,921

(22) Filed: Apr. 28, 2023

Related U.S. Application Data
(60) Provisional application No. 63/356,547, filed on Jun. 29, 2022.

(51) Int. Cl. G06Q 50/06; G06Q 10/0637

(52) U.S. Cl. CPC G06Q 50/06; G06Q 10/0637

(57) ABSTRACT

Systems and methods to identify a rehabilitation policy for water pipe networks are provided. A graph is built to represent a water pipe network including edges for each pipe and nodes for each water source or water user. An approach based on proximity analysis is used to determine the criticality of each node in the graph based on the spatial distribution of water demand type in the neighborhood where the node is located. The spatial variabilities of demand criticalities along with the spatial variabilities of the seismic ground motion intensities are integrated into the formulation of an optimization problem to identify rehabilitation policies the water supply network. A purpose-built simulated annealing algorithm is then used to solve the optimization problem. Results of the optimization may then be used to identify pipes in the water pipe network to replace based on a replacement budget.

### CROSS-REFERENCE TO RELATED APPLICATIONS

This application claims priority to U.S. Provisional Patent Application Ser. No. 63/356,547 filed on Jun. 29, 2022 and titled “PROACTIVE SEISMIC REHABILITATION OF WATER PIPE NETWORKS FOR EQUITABLE RECOVERY.” The disclosure of which is hereby incorporated by reference in its entirety.

### GOVERNMENT SUPPORT CLAUSE

This invention was made with government support under grant #1926792 awarded by the National Science Foundation. The government has certain rights in the invention.

### BACKGROUND

Operation of critical infrastructure facilities such as hospitals, firefighting stations, and disaster shelters are critical during a post-earthquake scenario. The serviceability of many such facilities is, in turn, dependent on the proper operation of water supply systems providing water to these facilities. Due to such dependency of disaster relief systems on water supply, having a resilient water supply system is even more critical in a post-earthquake scenario as compared to a normal operating condition. Extant pertinent literature ignores spatial variabilities of the water demand priorities. It assumes that the water demand originating from critical facilities, such as hospitals, and the water demand originating from less critical facilities, such as golf courses and temporary storage facilities, are of equal importance. This oversimplification has made existing models practically limited, especially in a post-earthquake scenario.

### SUMMARY

Systems and methods to identify an optimized proactive seismic rehabilitation policy for water pipe networks that considers spatial variabilities of demand criticalities and seismic ground motion intensities are provided. A graph is built to represent a water pipe network including edges for each pipe and nodes for each water source or water user. A novel approach based on proximity analysis is used to determine the criticality of each node in the graph where the criticality was established based on the spatial distribution of water demand type in the neighborhood where the node is located. The spatial variabilities of demand criticalities along with the spatial variabilities of the seismic ground motion intensities are integrated into the formulation of a stochastic combinatorial optimization problem to identify economical rehabilitation policies for enhancing seismic resilience of the water supply network. A purpose-built simulated annealing algorithm integrated with Monte Carlo simulation is then used to solve the optimization problem. Results of the optimization may then be used to identify pipes in the water pipe network to replace based on a replacement budget.

In an embodiment, a method for generating a rehabilitation plan for a commodity pipe network is provided. The method includes: receiving an indication of a pipe network by a computing device; generating a graph based on the pipe network by the computing device, wherein the graph includes a plurality of edges with each edge representing a pipe in the pipe network, and further wherein the graph includes a plurality of nodes, wherein each node represents either a commodity source or a commodity sink; calculating a spatially correlated peak ground velocity field for a scenario earthquake event in the pipe network by the computing device; based on the spatially correlated peak ground velocity field, assigning a damage value to each pipe by the computing device; for each node in the graph, calculating a nodal equity factor for the node by the computing device; receiving a maximum cost value by the computing device; and based on the maximum cost value, the nodal equity factor for each node, and the damage value assigned to each pipe, providing a rehabilitation policy for the pipe network by the computing device.

Implementations may include some or all of the following features. The damage value associated to each pipe is one of leak or break. Assigning a damage value to each pipe may include performing a Monte Carlo simulation using a probabilistic pipe damage model and the spatially correlated peak ground velocity field. The pipe network may be one or more of a water pipe network or a gas pipe network. Providing the rehabilitation policy for the pipe network may include: generating a plurality of different rehabilitation policies for the network; for each different rehabilitation policy calculating a post-earthquake Equity-based System Serviceability Index value; and providing the different rehabilitation policy with an optimal post-earthquake Equity-based System Serviceability Index value. The method may further include generating the plurality of different rehabilitation policies using an annealing algorithm. Calculating the post-earthquake Equity-based System Serviceability Index value for the rehabilitation policy may include solving the equation:

$$ESSI ( x ) = \frac{{\sum }_{j = 1}^{J} {\sum }_{i}^{N} {NS}_{ij} * {NEF}_{i}}{J {\sum }_{i}^{N} {NEF}_{i}}$$

where NSᵢⱼ={0 if Pᵢⱼ(x)<P_{threshold}; 1 if Pᵢⱼ(x)≥P_{threshold}}, where N is a total number of nodes in the graph, J is a total number of damage scenarios created by Monte Carlo Simulation, NSᵢⱼ is a Nodal Serviceability of a node i in the j^{th} damage scenario of Monte Carlo simulation, Pᵢⱼ(x) is a pressure at node i in the j^{th} damage scenario of Monte Carlo simulation for the rehabilitation policy x, and P_{threshold} is a minimum pressure required in a node.

In an embodiment, a system is provided. The system includes at least one computing device and a computer-readable medium. The computer-readable medium has computer-executable instructions stored thereon that when executed by the at least one computing device cause the system to: receive an indication of a pipe network; generate a graph based on the pipe network, wherein the graph includes a plurality of edges with each edge representing a pipe in the pipe network, and further wherein the graph includes a plurality of nodes, wherein each node represents either a commodity source or a commodity sink; calculate a spatially correlated peak ground velocity field for a scenario earthquake event in the pipe network; based on the spatially correlated peak ground velocity field, assign a damage value to each pipe; for each node in the graph, calculate a nodal equity factor for the node; receive a maximum cost value; and based on the maximum cost value, the nodal equity factor for each node, and the damage value assigned to each pipe, provide a rehabilitation policy for the pipe network.

Embodiments may include some or all of the following features. The damage value associated to each pipe may be one of leak or break. Assigning a damage value to each pipe may include performing a Monte Carlo simulation using a probabilistic pipe damage model and the spatially correlated peak ground velocity field. The pipe network may be one or more of a water pipe network or a gas pipe network. Providing the rehabilitation policy for the pipe network may include: generating a plurality of different rehabilitation policies for the network; for each different rehabilitation policy calculating a post-earthquake Equity-based System Serviceability Index value; and providing the different rehabilitation policy with the greatest post-earthquake Equity-based System Serviceability Index value.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for selecting a rehabilitation policy for a pipe network;

FIG. 2 is an illustration of an example tessellation methodology used to determine the spatial extent of each nodal service area;

FIG. 3 is an illustration of an exemplary method for generating a rehabilitation plan for a commodity pipe network;

FIG. 4 is an illustration of an exemplary method for selecting a rehabilitation policy for a pipe network; and

FIG. 5 shows an exemplary computing environment in which example embodiments and aspects may be implemented.

### DETAILED DESCRIPTION

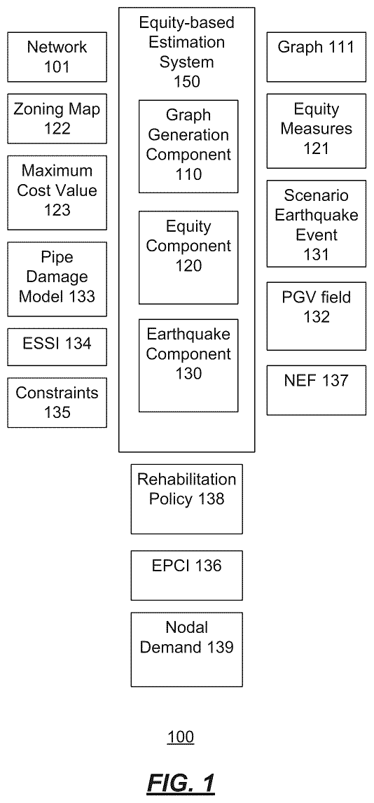

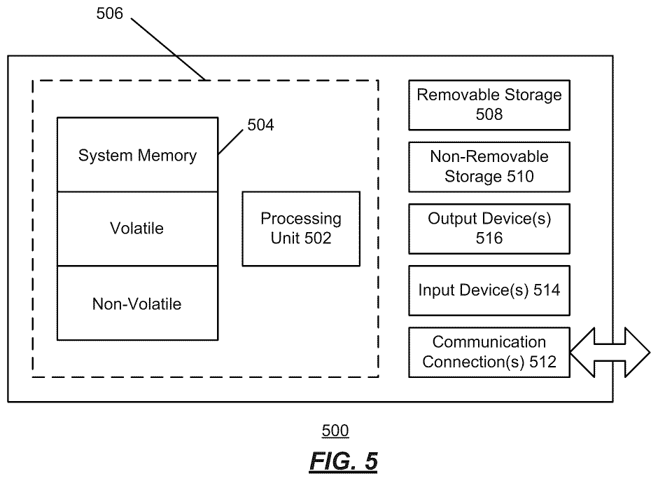

FIG. 1 is an illustration of an exemplary environment 100 for selecting a rehabilitation policy for a pipe network. As shown the environment 100 includes an equity-based estimation system 150. The equity-based estimation system 150 includes one or more components including a graph generation component 110, an equity component 120, and an earthquake component 130. Some or all of the system 150, including components, may be implemented by the computing system 500 illustrated with respect to FIG. 5.

The graph generation component 110 may generate a graph 111 that represents a water pipe network 101. The water pipe network 101 may be associated with particular city or municipality. While the present embodies are described with respect to water pipe network, other types of utilities may be considered besides water. For example, graph generation component 110 may generate a graph 111 representing a gas network.

In some embodiments, the generation component 110 may model the water pipe network as a directed graph 111 (G(V,E)) where V is the set of nodes of the water pipe network 101, and E is the set of edges or arcs representing the pipes in the network 101. Water sources such as rivers and tanks are represented as source nodes with negative water demand, while the nodes servicing the customers are represented as demand nodes with positive water demand. An adjacency matrix defines the network topology. Hydraulics of the network are defined by hydraulic parameters including water heads at water sources, pipes' lengths, pipes' diameters, pipes' frictional coefficients, and pump properties (if any) in addition to nodal water demands.

The seismic properties of the pipe network 101 are defined by parameters including pipe material, pipe diameter, and joint type. N valve configuration is assumed, where N isolation valves are assumed to be located at each junction with N incident pipes. As a result, each pipe is assumed to be capable of being isolated from the system.

The equity component 120 may calculate one or more equity measures 121 for the graph 111. The goal of the equity measures 121 may be to overcome the gap in current literature regarding the consideration of socioeconomic and spatial equity measures in calculating post-earthquake serviceability measures for water pipe networks. To quantify the socioeconomic and spatial equity measures in the vicinity of a water pipe network 101, the equity component 120 may use a zoning map 122 of the city or municipality associated with the water pipe network 101 under consideration. The zoning map 122 may be provided to the equity component 120 by a user or an administrator.

As may be appreciated, zoning maps 122 show how a local administration has enforced various land-use patterns within its administrative boundary. Such maps 122 are the primary means of land-use planning in many suburban, exurban, and even rural areas of the United States and many other countries. Such maps 122 provide valuable information regarding the distribution of different socioeconomic groups (age, income) and land-use (hospital, school, households) patterns in the vicinity of the water supply network.

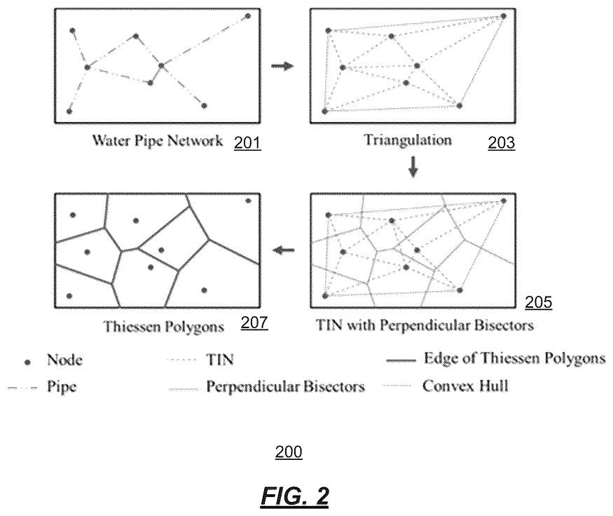

Nodal Equity Factors 137 (NEFs) are defined to map equity measures or inequality indices (e.g., Affordability Index, Atkinson Index, Gini Index) on graphs 111 based on the maps 122. NEFs 137 reflect variations in socioeconomic conditions (e.g., age, income, gender) and land-use patterns in the map 122. A NEF factor 137 is calculated for a graph 111 by the equity component 120 in two steps. First, the spatial extent of the nodal service area is estimated for each node in the graph 111 by the equity component 120. Second, each nodal service area is further analyzed by the equity component 120 to determine the NEF value 137 for each area. To determine the spatial extent of each nodal service area, Thiessen diagrams are used by the equity component 120. The process of creating Thiessen polygons using the spatial distribution of a graph 111 is illustrated in the method 200 of FIG. 2. Other methods may be used.

A Thiessen diagram is a network of Thiessen polygons where each Thiessen polygon is created based on proximity criteria with respect to the set of points on a plane. Thiessen polygons have the unique property that each polygon contains only one input point, and any location within a polygon is closer to its associated point than to the point of any other polygon.

Referring to FIG. 2, at 201 a graph 111 representing a water pipe network 101 is received by the equity component 120. At 203, a Triangular Irregular Network (TIN) is generated using Delaunay's triangulation algorithm by the equity component 120. At 205, the edges of Thiessen polygons are identified by drawing perpendicular bisectors for each edge in the Triangular Irregular Network by the equity component 120. At 207, the polygons are then used as estimates for the area served by each node of the graph 111 by the equity component 120. Following the estimation of nodal service areas, the NEF value 137 for each nodal service is calculated by the equity component 120 using information from the zoning map 122.

Returning to FIG. 1, the earthquake component 130 models the spatial variability of seismic ground motion intensity in the area of the network 101. In some embodiments, the earthquake component 130 may model the spatial variability of seismic ground motion intensity by first identifying a scenario-based earthquake event 131. Scenario-based earthquake events 131 allow for simulating the seismic ground motion intensities of an earthquake while considering the possible spatial correlation between the ground motions intensities. Consideration of such correlations is essential for a comprehensive seismic vulnerability assessment of spatially distributed systems such as water pipe networks. Additionally, scenario-based earthquake events simplify the communication of results to stakeholders who have non-technical backgrounds. Hence, the earthquake component 130 may use a scenario-based seismic hazard modeling for analyzing the seismic resilience of water pipe networks 101.

The earthquake component 130 may use numerous scenario earthquakes to evaluate the seismic resilience of the network 101 represented by the graph 111. Among these earthquakes, the earthquake component 130 may identify one specific earthquake that contributes most to the seismic hazard at the considered probability level (e.g., 2% in 50 years; return period of 2475 years). This identified earthquake is the scenario earthquake event 131. The scenario earthquake event 131 embodies the characteristics of the “low-probability-high-consequence events” that the water pipe network 101 managers are most interested in when making decisions regarding the seismic risk mitigation investments.

The selection of the scenario earthquake event 131 may be accomplished by the earthquake component 130 in the following stages. First, a return period of the earthquake or the probability of the scenario earthquake is selected by the earthquake component 130. This selection is based on existing seismic design practices in the water pipe rehabilitation industry and literature. The selection may also be based on the risk tolerance of the utility that is managing the water pipe networks and on the available rehabilitation resources.

After selecting the return period, the earthquake component 130 may perform seismic deaggregation analysis using a seismic deaggregation model. A suitable model is the seismic deaggregation model developed by the United States Geological Survey. Other models may be used.

This seismic deaggregation analysis helps to identify the contribution of all the possible earthquakes for a given location (centroid of the network 101), for a given seismic intensity parameter (1 s spectral acceleration), and the given return period (selected in step 1). The earthquake having the maximum contribution factor in the seismic deaggregation analysis is selected as the scenario earthquake event 131.

After the earthquake component 130 selects the scenario earthquake event 131, the seismogenic characteristics of the event 131 are extracted from earthquake databases such as the database maintained by USGS. Next, the earthquake component 130 uses Ground Motion Prediction Equations (GMPE), combined with a methodology proposed in the latest relevant literature (Zanini et al. 2016), to generate a spatially correlated Peak Ground Velocity (PGV) field 132. The general formulation of the GMPE is given by the log₁₀ (PGVᵢⱼ)=f(Mᵢ,Rᵢⱼ,θᵢ)+σ_{B}νᵢ+σ_{W}εᵢⱼ where PGVᵢⱼ is the PGV at a point j, Rᵢⱼ distance away from the fault i, generated by an earthquake of magnitude Mᵢ; θᵢ is the property associated with the fault i; σ_{B}νᵢ represents the inter-event residuals, and σ_{W}εᵢⱼ represents intra-event residual. Here, νᵢ and εᵢⱼ may be random vectors with a mean of zero and a normal distribution, while the standard deviations σ_{B} and σ_{W} of the vectors depend on the GMPE being used. ε=μ+LZ given by Weatherill et al. (2013) and Zanini et al. (2016) is used to incorporate spatial correlation that exists between the ground motion intensities of a seismic event where μ is zero vector, Z is a vector of random numbers with standard normal distribution, and L is given by LL^{T}=C where C is a covariance matrix. C is a function of σ(h_{j,k}), where σ(h_{j,k}) is the correlation coefficient quantifying the spatial correlation between intra-event PGV values calculated for point j and k. Here, σ(h_{j,k}) is calculated using

$$σ ( {h}_{j , k} ) = {e}^{( \frac{- 3 {h}_{j , k}}{b} )}$$

where h_{j,k} is the distance between point j and k, b is the distance beyond which the spatial correlation can be ignored. In some embodiments, b=30 km can be used. Subsequently, the average PGV (PGV) is calculated for each pipe and used for further analysis for a conservative estimate of post-earthquake serviceability.

As the pipe damages caused by an earthquake are random, they cannot be modeled in a deterministic way. Therefore, the earthquake component 130 may use probabilistic damage generation to analyze the expected post-earthquake serviceability of a water pipe network 101. To model such damage, the earthquake component 130 may perform a Monte Carlo simulation that generates thousands of system damage scenarios. The Monte Carlo simulation may be driven by a probabilistic pipe damage model 133. The probabilistic pipe damage model 133 generates individual pipe damages using a Poisson process formulated as shown by

$${dl}_{p , i} = {dl}_{p , i - 1} - \frac{1}{{RR}_{p , \underline{{PGV}_{p}}}} ln ( 1 - r )$$

where dl_{p,i} is the location of i^{th} damage in pipe p, dl_{p,i-1} is the location of i−1^{th} damage in pipe p,

$${RR}_{p , \underline{{PGV}_{p}}}$$

is the average number of expected damages in pipe p subjected to average peak ground velocity PGVₚ, and r is a random number between 0 and 1 with a uniform probability distribution.

$$\\ {RR}_{p , \underline{{PGV}_{p}}}$$

is calculated based on the seismic pipe fragility function as per ALA (2001). After identifying the location of random damages, the earthquake component 130 may classify the pipes into leaks and breaks. In some embodiments, the earthquake component 130 may classify the pipes using a probability matrix. To determine the adequate number of Monte Carlo simulations, a convergence study may be carried out.

The earthquake component 130 may integrate the post-earthquake hydraulic-based system serviceability with the NEF values 137 by defining a new network equity measure, called Post-earthquake Equity-based System Serviceability Index (ESSI) 134. The ESSI 134 for a given rehabilitation policy x is shown by

$$ESSI ( x ) = \frac{{\sum }_{j = 1}^{J} {\sum }_{i}^{N} {NS}_{ij} * {NEF}_{i}}{J {\sum }_{i}^{N} {NEF}_{i}}$$

where NSᵢⱼ={0 if Pᵢⱼ(x)<P_{threshold}; 1 if Pᵢⱼ(x)≥P_{threshold}}, where N is the total number of nodes in the system, J is the total number of damage scenarios created by Monte Carlo Simulation, NSᵢⱼ is the Nodal Serviceability of the node i in the j^{th} damage scenario of Monte Carlo simulation, Pᵢⱼ(x) is the pressure at node i in the j^{th} damage scenario of Monte Carlo simulation for a given rehabilitation policy x, and P_{threshold} is the minimum pressure required in a node. Pᵢⱼ(x) may be calculated from quasi-pressure-driven hydraulic analysis, which considers the hydraulic properties of the pipe, earthquake-induced damages, and network connectivity. Other methods may be used.

The earthquake component 130 may solve the optimization problem represented by the equations

$${max}_{x ∈ X} ESSI ( x ) and C ( x ) \leq {C}_{max} .$$

### Here,

$${max}_{x ∈ X} ESSI ( x )$$

that show that the post-earthquake equity-based system serviceability indicator 134 is being maximized with rehabilitation policy 138 x as the decision variable. C(x)≤Cₘₐₓ represents the rehabilitation resource constraint 135 which prevents the utility from spending more than a maximum cost (e.g., Cₘₐₓ) for the rehabilitation. The maximum cost is referred to as the maximum cost value 123. Here, X represents a set of all the possible rehabilitation policies 138. Due to the combinatorial decision space and the probabilistic nature of the objective function (ESSI(x)), the resulting optimization becomes a stochastic combinatorial optimization.

Due to the simulation-based objective function, which involves numerical solution of many non-linear and non-convex energy balance equations, common mathematical optimization tools such as gradient-based optimization could not be used to solve the optimization problem. Hence, a purpose-built simulated annealing algorithm is designed to solve the optimization problem.

The purpose-built simulated annealing algorithm used by the earthquake component 130 starts with an initial temperature T and an initial feasible solution, i.e., rehabilitation policy 138 x₀. Next, post-earthquake equity-based system serviceability of the initial solution i.e., ESSI(x₀) 134 is calculated. Following that, another potential solution is identified using a neighborhood function N(x₀, NEF). Typically, a random search around the current solution is adopted in simulated annealing as the neighborhood function. However, some information regarding promising areas of decision space might be available before the optimization starts. A random search ignores such information. Hence, here, a novel neighborhood search heuristic is created which can exploit the information available regarding the equity-informed criticality of pipes to individual nodal serviceability while retaining some of the ability of random neighborhood search to explore the decision space in an unbiased way to identify any complex interaction that might exist between the decision variables. This may be accomplished by carrying out half of the neighborhood searches as a random search, while another half of the neighborhood searches as biased search focused on rehabilitating more critical pipes. Other methods may be used.

In some embodiments, the earthquake component 130 may begin the creation of the search heuristic with an estimation of an equity-informed criticality of each pipe in the network for each node. This equity-informed criticality may be estimated in terms of the Equity-informed Pipe Criticality Index 136, which is created in this research. Equity-informed Pipe Criticality Index for a pipe p may be calculated for each pipe in the network using EPCIₚ=Σ_{ds}_{ₚ}₌₁^{DS}^{ₚ}Σₙ₌₁^{N}NEFₙ(1−NS_{ds}_{ₚ}ⁿ)p(dsₚ|P̅G̅V̅ₚ̅) where EPCIₚ is the equity-informed pipe criticality index of pipe p, dsₚ is a possible damage state (such as break, longitudinal crack, and annular disengagement) for pipe p, DSₚ is the total number of single pipe failure damage states possible for pipe p, N is the total number of nodes in the network, NEFₙ is the nodal equity factor of node n, NS_{ds}_{ₚ}ⁿ is nodal serviceability of node n calculated for a damage scenario when pipe p is subjected to damage ds at the middle of the pipe, and p(dsₚ|P̅G̅V̅ₚ̅) is the probability of pipe p being subjected to a single damage ds due to an average PGV field (P̅G̅V̅ₚ̅). p(dsₚ|P̅G̅V̅ₚ̅) is calculated using p(dsₚ|P̅G̅V̅ₚ̅)=p(dsₚ|SF)p(SF); p(SF)=RRₚ^{P̅G̅V̅}Lₚe^{(-RR}^{ₚ}^{^{P̅G̅V̅}}^{L}^{ₚ}⁾) where p(dsₚ|SF) is the probability that the pipe p is subjected to damage ds due to a failure event (SF) induced by an average PGV field (P̅G̅V̅), RRₚ^{P̅G̅V̅} is the expected pipe repair rate (i.e. expected damages in terms of leaks and breaks) for pipe p due to the P̅G̅V̅, and Lₚ is the length of pipe p. Here, (RRₚ^{P̅G̅V̅}Lₚe^{(-RR}^{ₚ}^{^{P̅G̅V̅}}^{L}^{ₚ}⁾) is the estimated pipe failure probability due to a failure event SF (leak or a break) induced by P̅G̅V̅. Similarly, a probability matrix may be used for the values of p(dsₚ|SF).

After the calculation of EPCIₚ 136, the earthquake component 130 may mutate a finite number of bits of the current rehabilitation string (x₀) in each neighborhood search. Out of this finite number of mutations, half of the mutations are done randomly while half of the mutations are done using the following heuristic.
Step 1: Sort the pipes in decreasing order of their EPCIₚ;
Step 2: Generate a uniformly distributed random number U.
Step 3: Calculate EPCI_{Sum_max} as Σₚ₌₁^{N}^{ₚ}EPCIₚ.
Step 4: Identify first i pipes from the sorted pipe queue such that the ratio of their EPCI sum to EPCI_{Sum_max} just exceeds U.
Step 5. Starting with the first pipe among the i−1 pipes, if any of the pipes in the sorted queue is not rehabilitated, select pipe for rehabilitation. If all the i−1 pipes are already selected for rehabilitation, then select any other unrehabilitated pipe randomly for rehabilitation.

Thus, the neighborhood of current selection is explored by combining random search and prioritization of pipes critical to nodes with high NEF values 137. After performing all the mutations, the earthquake component 130 may check the resulting neighboring solution for feasibility. If a neighboring solution is found infeasible, a neighborhood search is repeated. Then, the earthquake component 130 may be used to select or discard the new neighboring solution (xₙ). The Metropolis criterion-based selection step is executed in the following steps.
Step 1: Calculate EPCI(xₙ).
Step 2: If EPSI(xₙ)>EPCI(x₀) then replace old solution by the new solution (i.e. x₀=xₙ).

Else if

$$[ rand [ 0 , 1 ) < {e}^{( \frac{EPCI ( {x}_{n} ) - EPCI ( {x}_{0} )}{T} )}$$

replace the old solution by the new solution (i.e. x₀=xₙ).

Else keep old solution (i.e. x₀=x₀).

Finally, the earthquake component 130 checks the termination criterion (if T≥Tₘₐₓ). If the criterion is met, the simulated annealing is stopped by the earthquake component 130. If the termination criterion is not met (i.e., T<Tₘₐₓ), then the earthquake component 130 may decrease the temperature (T=T−δ(T) where δ(T) is the cooling function). Then the earthquake component 130 begins a new neighborhood solution search, and this process is continued till the termination criterion is met. At the termination, the solution with the highest EPCI 136 is termed as the optimal rehabilitation policy identified by the algorithm.

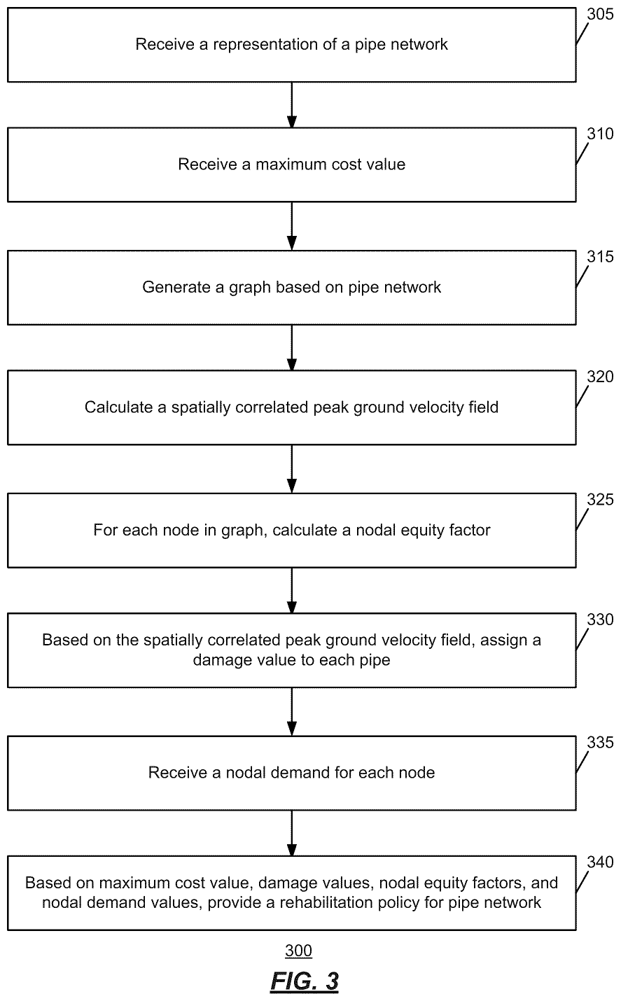

FIG. 3 is an illustration of an exemplary method 300 for generating a rehabilitation plan for a commodity pipe network. The method 300 may be implemented by the Equity-based Estimation System 150.

At 305, a representation of a pipe network is received. The representation of a pipe network 101 may be received by the graph generation component 110. The pipe network 101 may be a water or gas network. The pipe network 101 may be a pipe network 101 in a municipality or other location. The pipe network 101 may be at risk of damage due to seismic activity.

At 310, a maximum cost value is received. The maximum cost value 123 may be received by the earthquake component 130. The maximum cost value 123 may be the budget or total amount of money that a municipality has to rehabilitate the pipe network 101.

At 315, a graph is generated based on the pipe network. The graph 111 may be generated by the graph generation component 110. The graph 111 may include edges for each pipe in the pipe network 101 and nodes representing water (or gas) sources (i.e., water producers) or sinks (i.e., water users). Depending on the embodiment, an adjacency matrix may be used to define a topology of the graph 111. Other information included in the graph 111 may include pipe lengths, pipe diameters, pipe frictional coefficient, pump properties (if any) and demand values (positive or negative) for each node.

At 320, a spatially correlated peak ground velocity field is calculated. The PGV field 132 may be calculated by the earthquake component 130. In some embodiments, the PGV field 132 may be calculated by the earthquake component 130 by first selecting a scenario earthquake event 131 for the municipality associated with the pipe network 101. Seismogenic characteristics of the event may then be extracted and may be used to generate the PGV field 132 as described above.

At 325, for each node in the graph, a nodal equity factor is calculated. The NEF factors 137 may be calculated by the equity component 120 using one or more zoning maps 122. The NEF 137 associated with a node of the graph 111 may be based on a variety of inequality indexes and may be mapped to the node using one or more zoning maps 122. In some embodiments, the equity component 120 may map the NEF 137 to each node by generating a plurality of Thiessen diagrams from the zoning maps 122. Based on the location of each node in the Thiessen diagrams, the equity component 120 may assign the NEF factors 137 to the nodes.

At 330, based on the spatially correlated peak ground velocity field, assign a damage value to each pipe. The damage values may be assigned to each pipe (edge) by the earthquake component 130 using a pipe damage model and the PGV field 132. In some embodiments, the damage values may be assigned by performing a plurality of Monte Carlo simulations using the pipe damage model 133 and the PGV field 132. Other methods may be used. In some embodiments, each pipe (edge) may be assigned a damage value of either leak or break.

At 335, a nodal demand is received for each node. The nodal demand 139 for a node may be received by the earthquake component 130. The nodal demand 139 for a node may be a measure of how much water (or gas) is produced or used by the node.

At 340, a rehabilitation policy is provided for the pipe network based on maximum cost value, damage values, nodal equity factors, and nodal demand values. The rehabilitation policy 138 may be determined by the earthquake component 130 calculating a plurality of rehabilitation policies 138 with each rehabilitation policy identifying a subset of the pipes of the network 101 for repair or replacement. The earthquake component 130 may calculate an equity-informed serviceability index value 134 for each repaired or replaced pipe in the rehabilitation policy 138. The rehabilitation policy 138 with the greatest total equity-informed serviceability index value 134 may be provided as the rehabilitation policy 138.

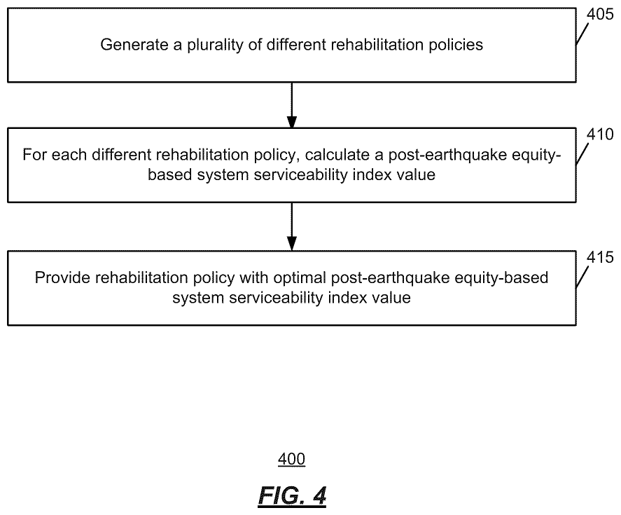

FIG. 4 is an illustration of an exemplary method 400 for selecting a rehabilitation policy for a commodity pipe network. The method 400 may be implemented by the Equity-based Estimation System 150.

At 405, a plurality of different rehabilitation policies is generated. The plurality of different rehabilitation polices 138 may be determined by the earthquake component 130. In some embodiments, the earthquake component 130 may generate the policies 138 using a simulated annealing algorithm that continues to generate different rehabilitation policies 138 that meet the maximum cost value 123 provided by the municipality until a stopping condition is met. During each iteration of the annealing algorithm, pipes may be selected for the rehabilitation using a neighborhood search where some number of pipes in the rehabilitation policy are randomly changed from a previous rehabilitation policy and some number of pipes are changed based on EPCI values 136. Other methods may be used.

At 410, for each different rehabilitation policy, a post-earthquake equity-based system serviceability index value is calculated. The earthquake component 130 may calculate the EPCI 136 for each pipe (edge) in a rehabilitation policy 138 and may calculate the EPCI 136 for the rehabilitation policy 138 as the sum of the EPCI 136 for each pipe in the rehabilitation policy 138.

At 415, a rehabilitation with the optimal post-earthquake equity-based system serviceability index value 134 is provided.

FIG. 5 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by the device 500 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by computing device 900. Any such computer storage media may be part of computing device 500.

Computing device 500 may contain communication connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising for generating a rehabilitation plan for a commodity pipe network comprising:
receiving an indication of a pipe network by a computing device;
generating a graph based on the pipe network by the computing device, wherein the graph includes a plurality of edges with each edge representing a pipe in the pipe network, and further wherein the graph includes a plurality of nodes, wherein each node represents either a commodity source or a commodity sink;
calculating a spatially correlated peak ground velocity field for a scenario earthquake event in the pipe network by the computing device;
based on the spatially correlated peak ground velocity field, assigning a damage value to each pipe by the computing device;
for each node in the graph, calculating a nodal equity factor for the node by the computing device;
receiving a maximum cost value by the computing device; and
based on the maximum cost value, the nodal equity factor for each node, and the damage value assigned to each pipe, providing a rehabilitation policy for the pipe network by the computing device.

2. The method of claim 1, wherein the damage value associated to each pipe is one of leak or break.

3. The method of claim 1, wherein assigning a damage value to each pipe comprises performing a Monte Carlo simulation using a probabilistic pipe damage model and the spatially correlated peak ground velocity field.

4. The method of claim 1, wherein the pipe network is one or more of a water pipe network or a gas pipe network.

5. The method of claim 1, wherein providing the rehabilitation policy for the pipe network comprises:
generating a plurality of different rehabilitation policies for the network;
for each different rehabilitation policy calculating a post-earthquake Equity-based System Serviceability Index value; and
providing a rehabilitation policy with an optimal post-earthquake Equity-based System Serviceability Index value.

6. The method of claim 5, further comprising generating the plurality of different rehabilitation policies comprises generating the plurality of different rehabilitation policies using an annealing algorithm.

7. The method of claim 1, wherein calculating the post-earthquake Equity-based System Serviceability Index value for the rehabilitation policy comprises solving the equation:
$$ESSI ( x ) = \frac{{\sum }_{j = 1}^{J} {\sum }_{i}^{N} {NS}_{ij} * {NEF}_{i}}{J {\sum }_{i}^{N} {NEF}_{i}}$$
where NSᵢⱼ={0 if Pᵢⱼ(x)<P_{threshold}; 1 if Pᵢⱼ(x)≥P_{threshold}}, where N is a total number of nodes in the graph, J is a total number of damage scenarios created by Monte Carlo Simulation, NSᵢⱼ is a Nodal Serviceability of a node i in the j^{th} damage scenario of Monte Carlo simulation, Pᵢⱼ(x) is a pressure at node i in the j^{th} damage scenario of Monte Carlo simulation for the rehabilitation policy x, and P_{threshold} is a minimum pressure required in a node.

8. A system for generating a rehabilitation plan for a commodity pipe network comprising:
at least one computing device; and
a computer-readable medium with computer-executable instructions stored thereon that when executed by the at least one computing device cause the system to:
receive an indication of a pipe network;
generate a graph based on the pipe network, wherein the graph includes a plurality of edges with each edge representing a pipe in the pipe network, and further wherein the graph includes a plurality of nodes, wherein each node represents either a commodity source or a commodity sink;
calculate a spatially correlated peak ground velocity field for a scenario earthquake event in the pipe network;
based on the spatially correlated peak ground velocity field, assign a damage value to each pipe;
for each node in the graph, calculate a nodal equity factor for the node;
receive a maximum cost value; and
based on the maximum cost value, the nodal equity factor for each node, and the damage value assigned to each pipe, provide a rehabilitation policy for the pipe network.

9. The system of claim 8, wherein the damage value associated to each pipe is one of leak or break.

10. The system of claim 8, wherein assigning a damage value to each pipe comprises performing a Monte Carlo simulation using a probabilistic pipe damage model and the spatially correlated peak ground velocity field.

11. The system of claim 8, wherein the pipe network is one or more of a water pipe network or a gas pipe network.

12. The system of claim 8, wherein providing the rehabilitation policy for the pipe network comprises:
generating a plurality of different rehabilitation policies for the network;
for each different rehabilitation policy calculating a post-earthquake Equity-based System Serviceability Index value; and
providing a rehabilitation policy with an optimal post-earthquake Equity-based System Serviceability Index value.

13. The system of claim 12, further comprising generating the plurality of different rehabilitation policies comprises generating the plurality of different rehabilitation policies using a simulated annealing algorithm.

14. A computer-readable medium with computer-executable instructions stored thereon that when executed by at least one computing device cause the at least one comp:
receive an indication of a pipe network;
generate a graph based on the pipe network, wherein the graph includes a plurality of edges with each edge representing a pipe in the pipe network, and further wherein the graph includes a plurality of nodes, wherein each node represents either a commodity source or a commodity sink;
calculate a spatially correlated peak ground velocity field for a scenario earthquake event in the pipe network;
based on the spatially correlated peak ground velocity field, assign a damage value to each pipe;
for each node in the graph, calculate a nodal equity factor for the node;
receive a maximum cost value; and
based on the maximum cost value, the nodal equity factor for each node, and the damage value assigned to each pipe, provide a rehabilitation policy for the pipe network.

15. The computer-readable medium of claim 14, wherein the damage value associated to each pipe is one of leak or break.

16. The computer-readable medium of claim 14, wherein assigning a damage value to each pipe comprises performing a Monte Carlo simulation using a probabilistic pipe damage model and the spatially correlated peak ground velocity field.

17. The computer-readable medium of claim 14, wherein the pipe network is one or more of a water pipe network or a gas pipe network.

18. The computer-readable medium of claim 14, wherein providing the rehabilitation policy for the pipe network comprises:
generating a plurality of different rehabilitation policies for the network;
for each different rehabilitation policy calculating a post-earthquake Equity-based System Serviceability Index value; and
providing a rehabilitation policy with an optimal post-earthquake Equity-based System Serviceability Index value.

19. The computer-readable medium of claim 18, further comprising generating the plurality of different rehabilitation policies comprises generating the plurality of different rehabilitation policies using an annealing algorithm.

20. The computer-readable medium of claim 14, wherein calculating the post-earthquake Equity-based System Serviceability Index value for the rehabilitation policy comprises solving the equation:
$$ESSI ( x ) = \frac{{\sum }_{j = 1}^{J} {\sum }_{i}^{N} {NS}_{ij} * {NEF}_{i}}{J {\sum }_{i}^{N} {NEF}_{i}}$$
where NSᵢⱼ={0 if Pᵢⱼ(x)<P_{threshold}; 1 if Pᵢⱼ(x)≥P_{threshold}}, where N is a total number of nodes in the graph, J is a total number of damage scenarios created by Monte Carlo Simulation, NSᵢⱼ is a Nodal Serviceability of a node i in the j^{th} damage scenario of Monte Carlo simulation, Pᵢⱼ (x) is a pressure at node i in the j^{th} damage scenario of Monte Carlo simulation for the rehabilitation policy x, and P_{threshold} is a minimum pressure required in a node.
